(19) United States
(12) Patent Application Publication
(10) Pub. No.: US 2008/0069126 A1
(43) Pub. Date: Mar. 20, 2008

(54) Method and system for buffering content

(75) Inventors: Jerald Robert Howcroft, Beverly Hills, MI (US); Mari S. Quick, Boerne, TX (US)

Correspondence Address: SCHWEGMAN, LUNDBERG & WOESSNER, P.A., P.O. BOX 2938, MINNEAPOLIS, MN, 55402, US

(73) Assignee: SBC Knowledge Ventures, L.P.

(21) Appl. No.: 11/521,206

(22) Filed: Sep. 14, 2006

(51) Int. Cl. H04L 12/56

(52) U.S. Cl. 370/412; 370/465

(57) ABSTRACT

A method and apparatus for buffering content. Video content is received for two or more channels. The video content for the two or more channels is retained within two or more buffers of a video content storage module to enable trick play while viewing the video content.

### FIELD

This application relates to a method and system for buffering content, and more specifically to techniques for implementing a multi-buffer content receiving device.

### BACKGROUND

Set-top boxes (STBs) may be used as intermediary devices to receive video content in video systems such as Internet Protocol Television (IPTV), cable, and direct broadcast satellite (DBS). Users of the STBs may specify the video content received, such as by selecting a channel for receiving the content. The STBs may process the video content received and provide the content to display devices for presentation.

The STBs may include digital video recorder (DVR) functionality to enable a user of a STB greater control over the video content. For example, the DVR functionality may enable the user to record video content to a storage module. The DVR functionality may also retain the video content within a single buffer within the STB to enable trick play, which may include fast forwarding, rewinding, recording and pausing the video content while viewers observe the presented video content on the display device.

### BRIEF DESCRIPTION OF DRAWINGS

Embodiments are illustrated by way of example and not limitation in the figures of the accompanying drawings, in which like references indicate similar elements and in which:

FIG. 1 illustrates a diagrammatic representation of an Internet Protocol Television (IPTV) system that may be used to provide video content used in an example embodiment;

FIG. 2 is a block diagram of a cable television system that may be used to provided video content used in an example embodiment;

FIG. 3 is a block diagram of a satellite system that may be used to provided video content used in an example embodiment;

FIG. 4 is a block diagram of a video content storage module in accordance with an example embodiment;

FIG. 5 is a flowchart illustrating a method in accordance with an example embodiment for utilizing an intermediary device;

FIG. 6 is a flowchart illustrating a method in accordance with an example embodiment for starting and maintaining buffers;

FIG. 7 is a flowchart illustrating a method in accordance with an example embodiment for starting and maintaining buffers;

FIG. 8 is a flowchart illustrating a method in accordance with an example embodiment for enacting viewing modifications;

FIG. 9 is a flowchart illustrating a method in accordance with an example embodiment for selecting a new channel; and

FIG. 10 illustrates a diagrammatic representation of machine in the example form of a computer system within which a set of instructions, for causing the machine to perform any one or more of the methodologies discussed herein, may be executed.

### DETAILED DESCRIPTION

In the following description, for purposes of explanation, numerous specific details are set forth in order to provide a thorough understanding of an embodiment of the present invention. It will be evident, however, to one skilled in the art that the present invention may be practiced without these specific details.

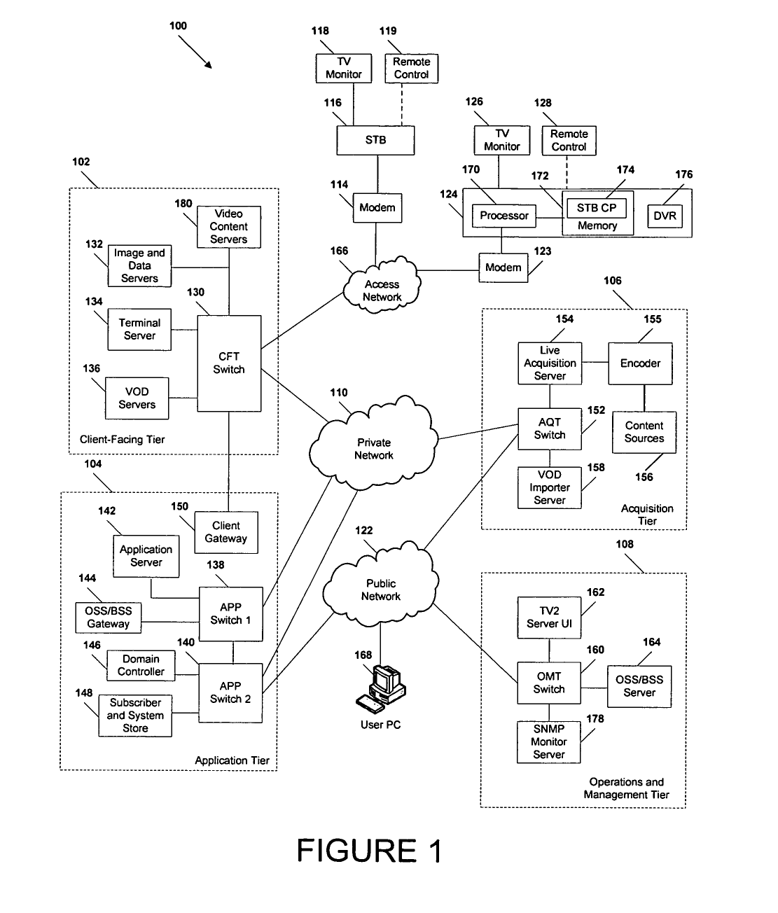

Referring to FIG. 1, an illustrative embodiment of an Internet Protocol Television (IPTV) system that may be used to provide content in the form of video content is illustrated and is generally designated 100. However, the use of other systems for providing video content and non-video content are also contemplated.

As shown, the system 100 can include a client facing tier 102, an application tier 104, an acquisition tier 106, and an operations and management tier 108. Each tier 102, 104, 106, 108 is coupled to a private network 110; to a public network 122, such as the Internet; or to both the private network 110 and the public network 122. For example, the client-facing tier 102 can be coupled to the private network 110. Further, the application tier 104 can be coupled to the private network 110 and to the public network 122. The acquisition tier 106 can also be coupled to the private network 110 and to the public network 122. Additionally, the operations and management tier 108 can be coupled to the public network 122.

As illustrated in FIG. 1, the various tiers 102, 104, 106, 108 communicate with each other via the private network 110 and the public network 122. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 122. Moreover, the acquisition tier 106 can communicate with the operations and management tier 108 via the public network 122. In a particular embodiment, elements of the application tier 104, including, but not limited to, a client gateway 150, can communicate directly with the client-facing tier 102.

As illustrated in FIG. 1, the client-facing tier 102 can communicate with user equipment via a private access network 166, such as an Internet Protocol Television (IPTV) access network. In an illustrative embodiment, modems, such as a first modem 114 and a second modem 123 can be coupled to the private access network 166. The client-facing tier 102 can communicate with a first representative set-top box device 116 via the first modem 114 and with a second representative set-top box device 124 via the second modem 123. The client-facing tier 102 can communicate with a large number of set-top boxes, such as the representative set-top boxes 116, 124, over a wide geographic area, such as a regional area, a metropolitan area, a viewing area, a designated market area or any other suitable geographic area, market area, or subscriber or customer group that can be supported by networking the client-facing tier 102 to numerous set-top box devices. In an illustrative embodiment, the client-facing tier, or any portion thereof, can be included at a video head-end office. In an example embodiment, the networks 110, 122, 166 may have multiple video content stream capability.

In a particular embodiment, the client-facing tier 102 can be coupled to the modems 114, 123 via fiber optic cables. Alternatively, the modems 114 and 123 can be digital subscriber line (DSL) modems that are coupled to one or more network nodes via twisted pairs, and the client-facing tier 102 can be coupled to the network nodes via fiber-optic cables. Each set-top box device 116, 124 can process data received via the private access network 166, via an IPTV software platform, such as Microsoft® TV IPTV Edition. In another embodiment, representative set-top boxes 116, 124 can receive data from private access network 166 through RF and other cable and/or satellite based networks.

Additionally, the first set-top box device 116 can be coupled to a first external display device, such as a first television monitor 118, and the second set-top box device 124 can be coupled to a second external display device, such as a second television monitor 126. Moreover, the first set-top box device 116 can communicate with a first remote control 119, and the second set-top box device can communicate with a second remote control 128.

In an example, non-limiting embodiment, each set-top box device 116, 124 can receive video content, which may include video and audio portions, from the client-facing tier 102 via the private access network 166. The set-top boxes 116, 124 can transmit the video content to an external display device, such as the television monitors 118, 126. Further, the set-top box devices 116, 124 can each include a STB processor, such as STB processor 170, and a STB memory device, such as STB memory 172, which is accessible to the STB processor 170. In one embodiment, a computer program, such as the STB computer program 174, can be embedded within the STB memory device 172. Each set-top box device 116, 124 can also include a video content storage module, such as a digital video recorder (DVR) 176. In a particular embodiment, the set-top box devices 116, 124 can communicate commands received from the remote control devices 119, 128 to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more image and data servers 132 that store still images associated with programs of various IPTV channels. The image and data servers 132 can also store data related to various channels, e.g., types of data related to the channels and to programs or video content displayed via the channels. In an illustrative embodiment, the image and data servers 132 can be a cluster of servers, each of which can store still images, channel and program-related data, or any combination thereof. The CFT switch 130 can also be coupled to a terminal server 134 that provides terminal devices with a connection point to the private network 110. In a particular embodiment, the CFT switch 130 can also be coupled to one or more video-on-demand (VOD) servers 136 that store or provide VOD content imported by the IPTV system 100. In an illustrative, non-limiting embodiment, the VOD servers 180 can include one or more unicast servers.

The client-facing tier 102 can also include one or more video content servers 180 that transmit video content requested by viewers via their set-top boxes 116, 124. In an illustrative, non-limiting embodiment, the video content servers 180 can include one or more multicast servers.

As illustrated in FIG. 1, the application tier 104 can communicate with both the private network 110 and the public network 122. The application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. In a particular embodiment, the application server 142 can provide applications to the set-top box devices 116, 124 via the private access network 166, which enable the set-top box devices 116, 124 to provide functions, such as display, messaging, processing of IPTV data and VOD material, etc. In a particular embodiment, the OSS/BSS gateway 144 includes operation systems and support (OSS) data, as well as billing systems and support (BSS) data. In one embodiment, the OSS/BSS gateway can provide or restrict access to an OSS/BSS server 164 that stores operations and billing systems data.

Further, the second APP switch 140 can be coupled to a domain controller 146 that provides web access, for example, to users via the public network 122. For example, the domain controller 146 can provide remote web access to IPTV account information via the public network 122, which users can access using their personal computers 168. The second APP switch 140 can be coupled to a subscriber and system store 148 that includes account information, such as account information that is associated with users who access the system 100 via the private network 110 or the public network 122. In a particular embodiment, the application tier 104 can also include a client gateway 150 that communicates data directly with the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116, 124 can access the IPTV system 100 via the private access network 166, using information received from the client gateway 150. In this embodiment, the private access network 166 can provide security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices from accessing the private network 110, by denying access to these devices beyond the private access network 166.

For example, when the first representative set-top box device 116 accesses the system 100 via the private access network 166, the client gateway 150 can verify subscriber information by communicating with the subscriber and system store 148 via the private network 110, the first APP switch 138, and the second APP switch 140. Further, the client gateway 150 can verify billing information and status by communicating with the OSS/BSS gateway 144 via the private network 110 and the first APP switch 138. In one embodiment, the OSS/BSS gateway 144 can transmit a query across the first APP switch 138, to the second APP switch 140, and the second APP switch 140 can communicate the query across the public network 122 to the OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, e.g., because it is connected to an unauthorized twisted pair, the client gateway 150 can block transmissions to and from the set-top box device 116 beyond the private access network 166.

As indicated in FIG. 1, the acquisition tier 106 includes an acquisition tier (AQT) switch 152 that communicates with the private network 110. The AQT switch 152 can also communicate with the operations and management tier 108 via the public network 122. In a particular embodiment, the AQT switch 152 can be coupled to a live acquisition server 154 that receives television or movie content, for example, from content sources 156 through an encoder 155. In a particular embodiment during operation of the IPTV system, the live acquisition server 154 can acquire television or movie content. The live acquisition server 154 can transmit the television or movie content to the AQT switch 152 and the AQT switch 152 can transmit the television or movie content to the CFT switch 130 via the private network 110.

Further, the television or movie content can be transmitted to the video content servers 180, where it can be encoded, formatted, stored, or otherwise manipulated and prepared for communication to the set-top box devices 116, 124. The CFT switch 130 can communicate the television or movie content to the modems 114, 123 via the private access network 166. The set-top box devices 116, 124 can receive the television or movie content via the modems 114, 123, and can transmit the television or movie content to the television monitors 118, 126. In an illustrative embodiment, video or audio portions of the television or movie content can be streamed to the set-top box devices 116, 124.

Further, the AQT switch 152 can be coupled to a video-on-demand importer server 158 that stores television or movie content received at the acquisition tier 106 and communicates the stored content to the VOD server 136 at the client-facing tier 102 via the private network 110. Additionally, at the acquisition tier 106, the video-on-demand (VOD) importer server 158 can receive content from one or more VOD sources outside the IPTV system 100, such as movie studios and programmers of non-live content. The VOD importer server 158 can transmit the VOD content to the AQT switch 152, and the AQT switch 152, in turn, can communicate the material to the CFT switch 130 via the private network 110. The VOD content can be stored at one or more servers, such as the VOD server 136.

When user issue requests for VOD content via the set-top box devices 116, 124, the requests can be transmitted over the private access network 166 to the VOD server 136, via the CFT switch 130. Upon receiving such requests, the VOD server 136 can retrieve the requested VOD content and transmit the content to the set-top box devices 116,124 across the private access network 166, via the CFT switch 130. The set-top box devices 116, 124 can transmit the VOD content to the television monitors 118, 126. In an illustrative embodiment, video or audio portions of VOD content can be streamed to the set-top box devices 116, 124.

FIG. 1 further illustrates that the operations and management tier 108 can include an operations and management tier (OMT) switch 160 that conducts communication between the operations and management tier 108 and the public network 122. In the embodiment illustrated by FIG. 1, the OMT switch 160 is coupled to a TV2 server 162. Additionally, the OMT switch 160 can be coupled to an OSS/BSS server 164 and to a simple network management protocol (SNMP) monitor 170 that monitors network devices within or coupled to the IPTV system 100. In a particular embodiment, the OMT switch 160 can communicate with the AQT switch 152 via the public network 122.

In an illustrative embodiment, the live acquisition server 154 can transmit the television or movie content to the AQT switch 152, and the AQT switch 152, in turn, can transmit the television or movie content to the OMT switch 160 via the public network 122. In this embodiment, the OMT switch 160 can transmit the television or movie content to the TV2 server 162 for display to users accessing the user interface at the TV2 server 162. For example, a user can access the TV2 server 162 using a personal computer (PC) 168 coupled to the public network 122.

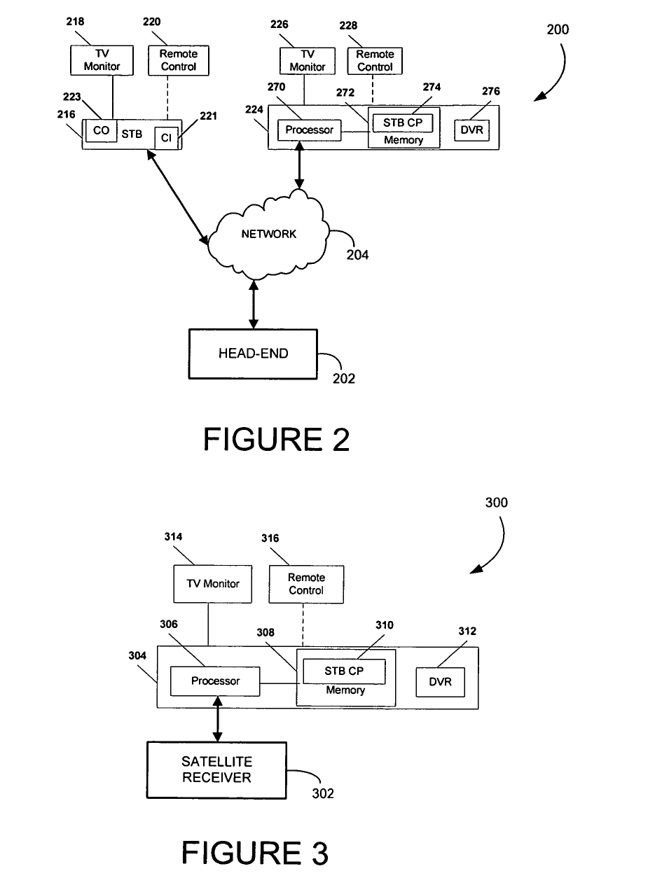

Referring to FIG. 2, an example embodiment of a cable television system 200 to provide video content is illustrated. While two STBs 216, 224 are shown in the representative embodiment, it should be appreciated that a plurality of STBS 216, 224 may be used with the cable television system 200.

A head-end 202 may provide video content through a network 204 to a STB 216 and a STB 224. The head-end 202 may collect a number of television channels and/or other video content such as on-demand video content for distribution to a number of subscribers through use of the STBs 216, 224. In an example embodiment, the head-end 202 may provide the video content in a digital format, in an analog format, or in both digital and analog formats.

In an example embodiment, the network 204 may be a cable-based network. For example, the head-end 202 may provide the video content over the network 204 through fixed optical fibers and/or coaxial cables to the STBs 216, 224. The network 204 may include a number of broadband amplifiers to effectuate communication between the head-end 202 and the STBs 216, 224. In an example embodiment, the network 204 may be a wireless network.

The STB 216 may be coupled to a first external display device, such as a first television monitor 218, and the STB 224 may be coupled to a second external display device, such as a second television monitor 226. Moreover, the first STB 216 may communicate with a first remote control 210, and the STB 224 may communicate with a second remote control 228. In an example embodiment, the STBs 216, 224 may communicate commands received from the remote control devices 210, 228 to the head-end 202 via the network 204.

In an example embodiment, each STB 216, 224 may receive video content, which may include video and audio portions, from the head-end 202 via the network 204. For example, the STB 216 may receive the video content through one or more content inputs 221. The STBs 216, 224 may provide the video content to an external display device, such as the television monitors 218, 226. For example, the STB 216 may provide the video content through one or more content outputs 223. Further, the STBs 216, 224 may each include a STB processor, such as STB processor 270, and a STB memory device, such as STB memory 272, which is accessible to the STB processor 270. In an example embodiment, a computer program, such as the STB computer program 274, may be embedded within the STB memory device 272. Each STB 216, 224 may also include a video content storage module, such as a digital video recorder (DVR) 276. An example embodiment of the video content storage module is described in greater detail below.

In an example embodiment, STBs 216, 224 may each include two or more tuners to enable presentation of a respective number of video content signals.

Referring to FIG. 3, an example embodiment of a satellite system 300 to provide video content is illustrated. In an example embodiment, the satellite system 300 may be a direct broadcast satellite (DBS) system. In an example embodiment, the satellite system 300 may be a television receive-only (TVRO) system.

The STB 304 may receive video content, which may include video and audio portions, from the a satellite receiver 302. The satellite receiver 302 may receive data including video content from one or more broadcast sources (not shown) over a broadcast network (not shown). In an example embodiment, the satellite receiver 302 may include a smart card receiver (not shown) and an associated smart card (not shown) for enabling receipt of certain video content. In an example embodiment, the satellite receiver 302 may include a receiving dish for receiving the video content from the broadcast sources. For example, the satellite receiver 302 may include a DBS receiver. In an example embodiment, the satellite receiver 302 and the STB 304 may be embodied in a single device.

The STB 304 may provide the video content to an external display device, such as the television monitors 314. Further, the STB 304 may include a STB processor, such as STB processor 306, and a STB memory device, such as STB memory 308, which is accessible to the STB processor 306. In an example embodiment, a computer program, such as the STB computer program 310, may be embedded within the STB memory device 308. The STB 304 may include a video content storage module, such as a digital video recorder (DVR) 312. An example embodiment of the video content storage module is described in greater detail below.

The STB 304 may be coupled to an external display device, such as a television monitor 314 and may communicate with a remote control 316. In an example embodiment, the STBs 304 may communicate commands received from the remote control device 316 to the satellite receiver 302.

In an example embodiment, the STB 304 may include two or more tuners to enable reproduction of a respective number of video content signals.

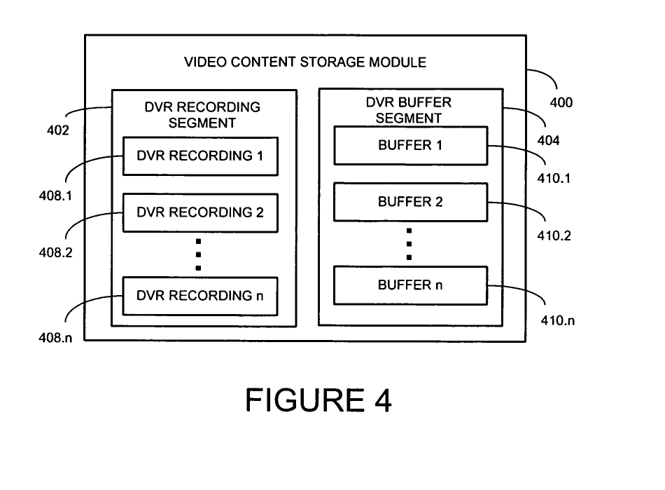

Referring to FIG. 4, an example embodiment of a video content storage module 400 is illustrated. In an example embodiment, the video content storage module 400 may be included on an intermediary device, such as the STBs 116, 124, 216, 224, 304 (see FIGS. 1-3). In an example embodiment, the DVR 176, 276, 312 may include the video content storage module 400.

The video content storage module 400 may include a DVR recording segment 402 and a DVR buffer segment 404. In an example embodiment, the DVR recording segment 402 and the DVR buffer segment 404 may be partitioned from a single storage of the intermediary device. For example, portioning the intermediary device may include defining a first portion of the video content storage module as the DVR buffer segment 404 and defining a second portion of the video content storage module as a DVR recording segment 402. In an example embodiment, the DVR recording segment 402 and the DVR buffer segment 404 may each respectively be on a first storage and a second storage of the intermediary device.

The DVR recording segment 402 may be a recording storage in which a number of DVD recordings 408.1 408.n are stored. The DVR recordings 408.1-408.n may include video programs recorded and stored within the video content storage module 400, such as for subsequent viewing by a user of the intermediary device, transferring the video programs to a portable playback device, recording the DVR recordings 408.1-408.n to a digital versatile disc (DVD), and the like. In an example embodiment, the DVD includes standard discs, high definition DVDs (HD-DVD) and Blu-Ray DVDs. For example, the DVR recordings 408.1-408.n may include video programs that have been selected by a user of the intermediary device, logic (e.g., STB computer program 174, 274, 310) on the video content storage module 400, or a third party (see FIGS. 1-3). In an example embodiment, the DVR recordings 408.1-408.n may be retained within the DVR recording segment 402 until deleted by a user, after a period of time since creation of a particular DVR recording 408, as defined by broadcasters of the video programs, and the like.

The DVR buffer segment 404 may be a buffer storage and include a number of buffers 410.1-410.n. Each buffer 410 (e.g., a first channel buffer and a second channel buffer) may define a memory portion configured to retain a buffered portion of content from a selected channel being received by the intermediary device.

In an example embodiment, the buffered portion may be limited by recording time (e.g., thirty minutes per buffer 410), an amount of storage space allocated to a particular buffer 410, a program being recorded, and the like. In an example embodiment, the video content stored in the buffers 410.1-410.n may be selected for trick play during receipt of the video content, such as by fast forwarding, rewinding, recording, repeating and pausing the video content.

In an example embodiment, the DVR buffer segment 404 may include at least two buffers 410.1-410.n, each of the at least two buffers 410.1-410.n retaining the video content of a selected channel of two or more channels to enable trick play. In an example embodiment, each of the buffers 410.1-410.n may be a same buffer size. In an example embodiment, each of the buffers 410.1-410.n may include different buffer sizes.

In an example embodiment, the buffers 410.1-410.n may be allocated for each stream of the video content designated by channel selections. In an example embodiment, the buffers 410 may be allocated for each signal of the video content tuned by channel selections. Other allocations of the buffers 410.1-410.n are also contemplated.

In an example embodiment, the video content storage module 400 may be managed by the STB computer program 174, 274, 310 (see FIGS. 1-3).

In an example embodiment, a graphical user interface (GUI) may be used on the intermediary device to indicate the DVR recordings 408.1-408.n in the DVR recording segment 402 and the video content signals available in the buffers 410.1-410.n of the buffer segment 404. For example, the GUI may include a program guide, where the program guide includes an indication of which of the channels are being buffered in the buffers 410.1-410.n.

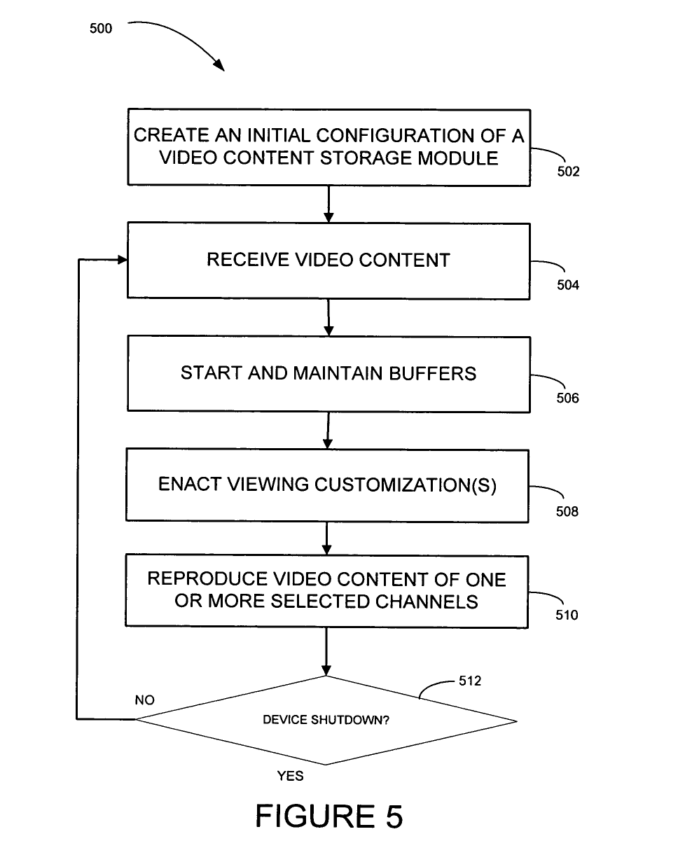

Referring to FIG. 5, a method 500 in accordance with an example embodiment for utilizing an intermediary device is illustrated. In an example embodiment, the intermediary device may include the STBs 116, 124, 216, 224, 304 (see FIGS. 1-3).

An initial configuration of a video content storage module 400 may be created at block 502. For example, the initial configuration may include defining a first portion of the video content storage module 400 allocated for the DVR recording segment 402 and a second portion of the video content storage module 400 the DVR buffer segment 404. In an example embodiment, the first portion and/or the second portion of the video content storage module 400 may be dynamically altered, such as by the intermediary device or a user of the intermediary device. In an example embodiment, the initial configuration may include defining a buffer number of the buffers 410.1-410.n within the DVR buffer segment 404. In an example embodiment, the initial configuration may include defining a buffer size of the buffers 410.1-410.n within the DVR buffer segment 404.

Video content may be received by the intermediary device at block 504. For example, the video content may be received for one or more channels. In an example embodiment, the video content may be received via a video content stream. In an example embodiment, the video content may be received via a video content signal.

In an example embodiment, a processor of the intermediary device may be configured to process the video content from one or more channels. For example, the processor may include the processor 170, 270, 306 (see FIGS. 1-3).

In an example embodiment, the video content may be received via a multicast stream. In an example embodiment, the video content may be received via a unicast stream. In an example embodiment, the video content may be encoded in a digital format such as MPEG2 or MPEG4 and encapsulated into a TCP/IP R-UDP frame for network distribution. In an example embodiment, the video content may be received a single video content signal capable of simultaneously transporting multiple channels of video content.

One or more buffers 410.1-410.n may be started and maintained at block 506. In an example embodiment, once the buffers 410.1-410.n have been started at block 506, the method 500 may maintain the buffers 410.1-410.n. Example embodiments of starting and maintaining buffers 410.1-410.n are described in greater detail below.

One or more viewing customizations may be enacted at block 508. For example, viewing customizations may alter presentation of content for reproduction by the intermediary device. An example embodiment of enacting viewing customizations is described in greater detail below.

Video content of one or more selected channels may be reproduced at block 510. In an example embodiment, video content from the one or more selected channels may selectively be reproduced from the one or more buffers 410.1-410.n. For example, the video content of a number of selected programs may be reproduced based on capabilities of the recording/playing device and whether a TV monitor 118, 126, 218, 226, 314 (see FIGS. 1-3) is capable of presenting more than one selected channel simultaneously. In an example embodiment, the intermediary device at block 510 may add an overlay to the video content to indicate which of the selected channels are being buffered.

At decision block 512, the method 500 may determine whether the intermediary device has been shutdown. For example, the intermediary device may shutdown based on instructions from a user, an error with the intermediary device, when an unused device threshold time is met, and the like. If the device has not been shutdown, the method 500 may return to block 504. If the device has not been shutdown, the method 500 may terminate.

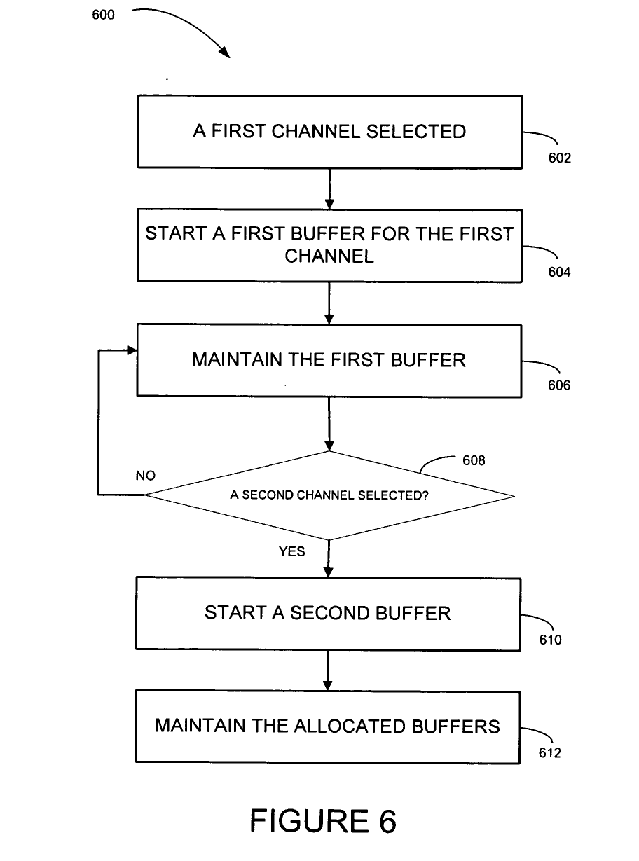

Referring to FIG. 6, a method 600 in accordance with an example embodiment for starting and maintaining buffers is illustrated. In an example embodiment, the method 600 may be performed at block 506 (see FIG. 5).

A first channel selection for video content may be received by an intermediary device at block 602. For example, the first channel may be a physical or virtual location over which a television channel with video content is delivered. In an example embodiment, the intermediary device may include the STBs 116, 124, 216, 224, 304 (see FIGS. 1-3). For example, a user may select the first channel by use of the remote control 119, 128, 220, 228, 316. In an example embodiment, the intermediary device may include the video content storage module 400 (see FIG. 4).

A first buffer 410.1 of the number of buffers 410.1-410.n (see FIG. 4) of the DVR buffer segment 404 may be started for the first channel at block 604. For example, the buffers 410.1-410.n may each be temporary memory capable of retaining video content (e.g., for trick play) and may be implemented in hardware, software, or a combination of hardware and software. In an example embodiment, starting the first buffer 410.1 may include allocating a portion of the DVR buffer segment 404 for the first buffer 410.1.

The first buffer 410.1 may be maintained at block 606. For example, the first buffer 410.1 may be maintained by retaining the video content of the first channel in the first buffer 410.1. In an example embodiment, the first buffer 410.1 may continue to receive video content from the first channel regardless of which portion of the video content is being reproduced for a viewer to watch.

At decision block 608, the method 600 may determine whether a second channel has been selected for video content. If the second channel has not been selected, the method 600 may return to block 606. If the channel has been selected at decision block 608, the method 600 may proceed to decision block 610.

The method 600 may start a second buffer 410.2 at decision block 610. In an example embodiment, starting the second buffer 410.2 may include allocating a portion of the DVR buffer segment 404 for the second buffer 410.2.

At block 612, all allocated buffers 410.1-410.n (e.g., the first buffer 410.1 and the second buffer 410.2) may be maintained. For example, the first buffer 410.1 may be maintained by retaining the video content of the first channel in the first buffer 410.1 while the second buffer 410.2 may be maintained by retaining the video content of the second channel. In an example embodiment, the first buffer 410.1 may continue to receive video content from the first channel and the second buffer 410.2 may continue to receive video content from the second channel regardless of which portion of the video content or which channel is being reproduced for presentation to a viewer to watch.

In an example embodiment, maintaining the allocated buffers 410.1-410.n may include storing video content as one of the DVR recordings 408.1-408.n when there is no space remaining in the buffers 410.1-410.n. In an example embodiment, maintaining the allocated buffers 410.1-410.n may include limiting video content in the buffers 410.1-410.n by deleting oldest video content when no space remains in the buffers 410.1-410.n. After completing the operations at block 612, the method 600 may terminate.

In an example embodiment, starting a first buffer 410.1 at block 604 may include initializing a first channel buffer 410.1 to receive the video content for a first channel of the video content and initializing a second buffer 410.2 at block 610 may include initializing a second channel buffer 410.2 to receive the video content for a second channel.

In an example embodiment, the video content may be provided a first channel buffer 410.1 or the second channel buffer 410.2 to a display device for presentation of the video content. In an example embodiment, the video content may be selected from the first channel buffer 410.1 and/or the second channel buffer 410.2 for trick play during receipt of the video content.

In an example embodiment, the video content from a plurality of channels for an IPTV may be received and retained respectively within a plurality of buffers 410.1-410.n of a video content storage module 300, a channel change selection may be received for a new IPTV channel, a selected buffer 410 from among the plurality of buffers 410.1-410.n may be reallocated, and the selected buffer 410 may be associated with the new IPTV channel.

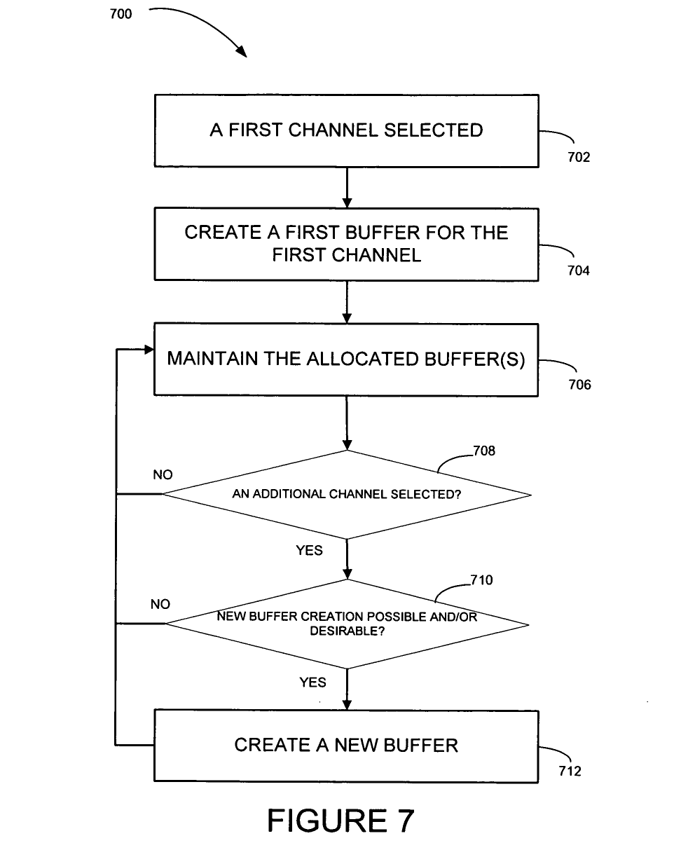

Referring to FIG. 7, a method 700 in accordance with an example embodiment for starting and maintaining buffers is illustrated. In an example embodiment, the method 700 may be performed at block 506 (see FIG. 5).

A first channel may be selected at block 702. For example, the first channel may be a physical or virtual location over which a television channel with video content is delivered. In an example embodiment, the intermediary device may include the STBs 116, 124, 216, 224, 304 (see FIGS. 1-3). For example, a user may select the first channel by use of the remote control 119, 128, 220, 228, 316. In an example embodiment, the intermediary device may include the video content storage module 400 (see FIG. 4). In an example embodiment, the operations performed at block 602 (see FIG. 6) may be performed at block 702.

A first buffer may be created on a video content storage module 400 (see FIG. 4) for the first channel at block 704. For example, the first buffer 410.1 may be maintained by receiving and storing the video content of the first channel in the first buffer 410.1. In an example embodiment, the operations performed at block 604 (see FIG. 6) may be performed at block 704.

At block 706, the one or more buffers 410.1-410.n may be maintained. For example, each of the buffers 410.1-410.n may be maintained by retaining the video content from an associated channel. In an example embodiment, each of the buffers 410.1-410.n may continue to receive video content from the associated channel regardless of which portion of the video content or which channel is being reproduced for presentation to a viewer to watch.

At decision block 708, the method 700 may determine whether an additional channel has been selected. If the additional channel has not been selected, the method 700 may return to block 706. If the additional channel has been selected, the method 700 may proceed to decision block 710.

The method 700 may determine at decision block 710 whether creation of a new buffer 410 is possible and/or desirable. For example, the creation of the new buffer 410 may be possible when there is a buffer space available for the buffer 410 within the DVR buffer segment 404. For example, the buffer space may be an unused portion of the DVR buffer segment 404 or space previously allocated to other buffers 410.1-410.n that may been reallocated for the new buffer 410.

In an example embodiment, the creation of the new buffer 410 may be desirable when a user confirms a desire to create the new buffer 410. In an example embodiment, the creation of the new buffer 410 may be desirable when reducing size of other buffers 410.1-410.n may not fall below a size threshold. In an example embodiment, the creation of the new buffer may be desirable when a buffer space is available for the new buffer 410.

If creation of the new buffer 410 is not possible and/or desirable at decision block 710, the method 700 may return to block 706. If creation of the new buffer 410 is possible and/or desirable, the method 700 may create a new buffer 410 in the DVR buffer segment 404 at block 712 and return to block 706. In an example embodiment, creating the new buffer 410 may include reducing buffer allocation to existing buffers 410.1-410.n by a pro-rata portion to allocate space for the new buffer 410. For example, a new channel buffer may be created by reducing buffer allocation of space of a first channel buffer 410.1 and a second channel buffer 410.2 by a pro-rata portion and allocating a freed portion of the space for a new channel buffer 410.3. In an example embodiment, creating the new buffer 410 may include utilizing a portion of the buffer segment 404 available for buffer allocation of the new buffer 410.

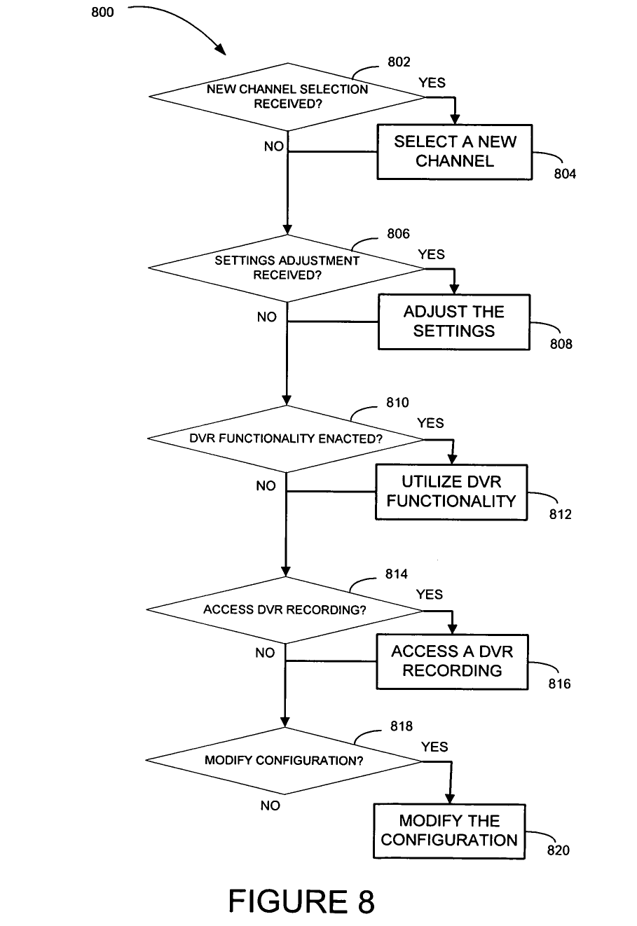

Referring to FIG. 8, a method 800 in accordance with an example embodiment for enacting viewing modifications is illustrated. In an example embodiment, the method 800 may be performed at block 508 (see FIG. 5).

In an example embodiment, the method 800 may operate on an intermediary device. For example, the intermediary device may include the STBs 116, 124, 216, 224, 304 (see FIGS. 1-3). In an example embodiment, the intermediary device may include the video content storage module 400 (see FIG. 4).

The method 800 may determine whether a new channel selection has been received at decision block 802. For example, the new channel selection may be received from a user directly on the intermediary device or through use of the remote control 119, 128, 220, 228, 316 (see FIGS. 1-3).

If the new channel selection has been received, the method 800 at block 804 may make the new channel selection. An example embodiment of making a new channel selection is described in greater detail below. If the new channel selection has not been received at decision block 802 or after block 804, the method 800 may proceed to decision block 806.

At decision block 806, the method 800 may determine whether a settings adjustment has been received. If the settings adjustment has been received, the method 800 may adjust the settings at block 808. For example, the settings adjustment may include adjusting the settings of the intermediary device such as audio settings (e.g., volume, audio quality, etc.), video settings (e.g., video quality, color levels, etc.) and other device settings. If the settings adjustment has not been received at decision block 806 or after block 808, the method 800 may proceed to decision block 810.

The method 800 may determine whether DVR functionality has been enacted at decision block 810. If the DVR functionality has been enacted, the method 800 at block 812 may utilize DVR functionality. For example, utilizing the DVR functionality may include trick play (e.g., enabling a user to fast forward, rewind, pause and record video content from the buffers 410.1-410.n during receipt of the video content). If the DVR functionality has not been enacted at decision block 810 or after block 812, the method 800 may proceed to decision block 814.

At decision block 814, the method 800 may determine whether a DVR recording 408 (see FIG. 4) is being accessed. If the DVR recording 408 is being accessed, the method 800 may access the DVR recording 408 at block 816. For example, accessing the DVR recording 408 may include reproducing the DVR recording 408 for viewing on the television monitor 118, 126, 218, 226, 314 (see FIGS. 1 and 2) or burning the DVR recording 408 to a DVD. If the DVR recording 408 has not been accessed at decision block 814 or after block 816, the method 800 may proceed to decision block 818.

The method 800 may determine at decision block 818 whether to modify a configuration, such as the configuration of the intermediary device. If a determination is made to modify the configuration, the configuration of the intermediary device may be modified at block 820. For example, modifying the configuration may include modifying the initial configuration of the video content storage module 400 of the intermediary device.

If a determination is made not to modify the configuration at decision block 818 or after block 820, the method 800 may terminate.

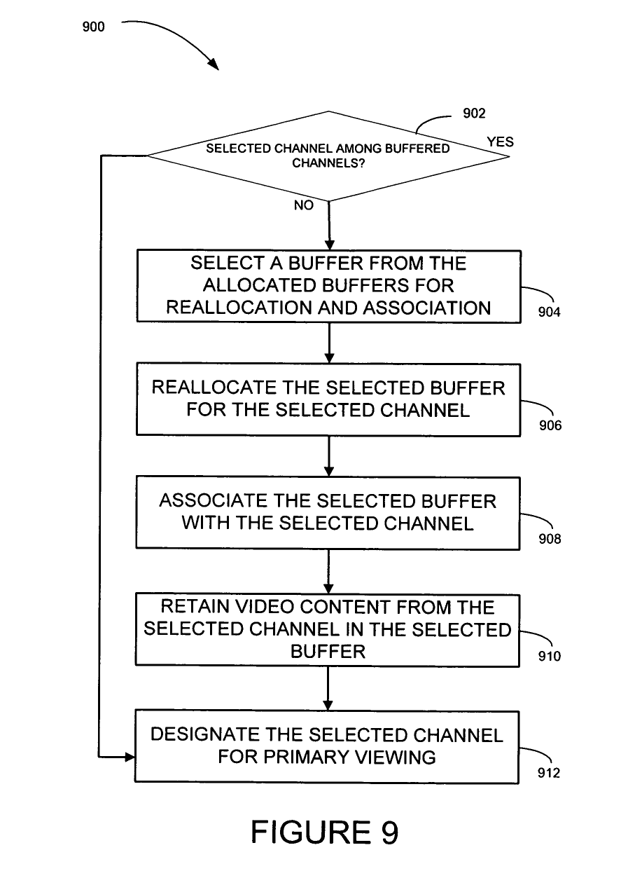

Referring to FIG. 9, a method 900 in accordance with an example embodiment for selecting a new channel is illustrated. In an example embodiment, the method 900 may be performed at block 804 (see FIG. 8).

In an example embodiment, the method 900 may operate on an intermediary device. For example, the intermediary device may include the STBs 116, 124, 216, 224, 304 (see FIGS. 1-3). In an example embodiment, the intermediary device may include the video content storage module 400 (see FIG. 4).

At decision block 902, the method 900 may determine whether a selected channel is among the channels being buffered by the intermediary device with a video content storage module 400 (see FIG. 4). For example, the selected channel may be a channel selected at decision block 802 (see FIG. 8). If the selected channel is among the channels being buffered by the buffers 410.1-410.n (see FIG. 4), the method 900 may proceed to block 910. If the channel is not among the channels being buffered at decision block 902, the method 900 may proceed to block 904.

One of the buffers 410.1-410.n may be selected from the allocated buffers 410.1-410.n for reallocation and association at block 904. In example embodiment, the buffer 410 selected from the allocated buffers 410.1-410.n for reallocation and association may be an oldest buffer 410 of the buffers 410.1-410.n. In example embodiment, the buffer 410 selected from the allocated buffers 410.1-410.n for reallocation and association may be a designated buffer 410 by the user from the buffers 410.1-410.n. Other buffer designations for reallocation and association are also contemplated.

The buffer 410 selected for reallocation may be reallocated for the new channel at block 906. In an example embodiment, reallocating the buffer 410 selected for reallocation may include discarding the previously buffered video content. In an example embodiment, reallocating the buffer 410 selected for reallocation may include storing the previously buffered video content as one of the DVR recordings 408.1-408.n (see FIG. 4). In an example embodiment, reallocating the buffer 410 selected for reallocation may include retaining in the buffer 410 selected for reallocation previously buffered video content. In an example embodiment, reallocating the buffer 410 selected for reallocation may include discarding previously buffered video content in the buffer 410 selected for reallocation.

The selected buffer 410 may be associated with the selected channel at block 908, such that the video content to be buffered by the selected buffer 410 may be from the selected channel.

The method 900 may retain the video content from the channel selection in the selected buffer 410 at block 910. For example, each of the buffers 410.1-410.n may respectively receive content from associated channels.

At block 912, the selected channel may be designated for primary viewing. In an example embodiment, the selected channel may be the only channel sent to the television monitor 118, 126, 218, 226, 314 (see FIGS. 1-3). In an example embodiment, the selected channel may be an only channel sent to the television monitor 118, 126, 218, 226, 314. In an example embodiment, the selected channel may be a primary channel sent to the television monitor 118, 126, 218, 226, 314 and another channel may be a picture-in-picture channel sent to the television monitor 118, 126, 218, 226, 314. In an example embodiment, the selected channel may be one of several channels sent as primary channels for viewing multiple channels simultaneously to the television monitor 118, 126, 218, 226, 314.

In an example embodiment, the method 900 may enable a user of the intermediary device to switch between video content signals to watch different programs while maintaining the buffers 410.1-410.n to provide trick play usage for the different programs. For example, a user may be able to rewind in each of the buffers 410.1-410.n to view the different programs from a time at which their respective buffers 410.1-410.n were created.

In an example embodiment, a user may press a key on the remote control 119, 128, 220, 228, 316 (see FIGS. 1-3) to switch between the buffers 410.1-410.n. In an example embodiment, when the selected channel is not among the buffered channels at decision block 902, the method 900 may permit the user of the intermediary device to designate one of the buffers 410.1-410.n for reallocation and association. For example, the user may choose to designate the buffer 410 for reallocation and association, choose to not buffer the new channel selection, or cancel the new channel selection.

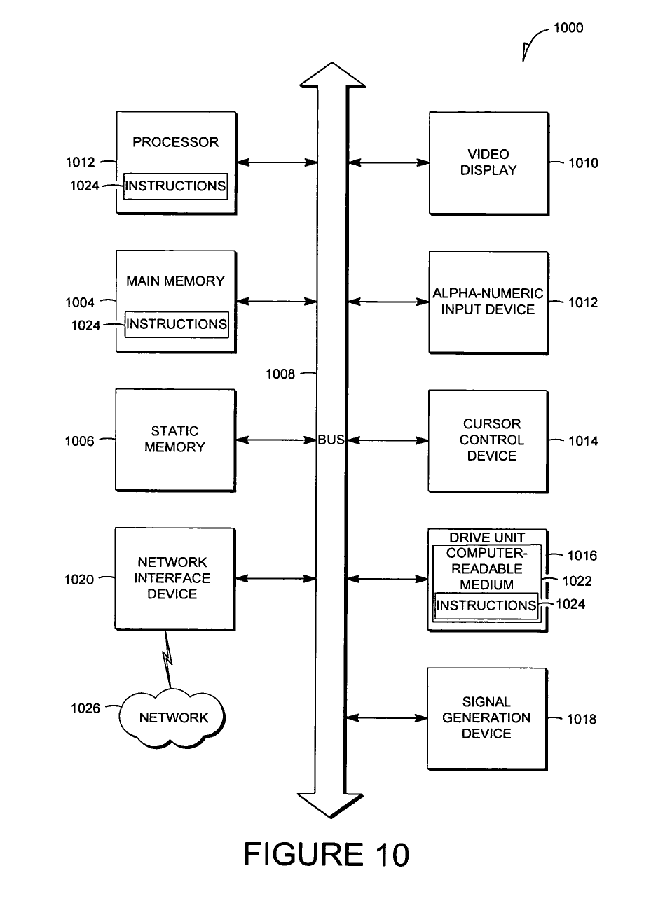

FIG. 10 shows a diagrammatic representation of machine in the example form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1012 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions and data structures (e.g., software 1024) embodying or utilized by any one or more of the methodologies or functions described herein. The software 1024 may also reside, completely or at least partially, within the main memory 1004 and/or within the processor 1012 during execution thereof by the computer system 1000, the main memory 1004 and the processor 1012 also constituting machine-readable media.

The software 1024 may further be transmitted or received over a network 1026 via the network interface device 1020 utilizing any one of a number of well-known transfer protocols (e.g., HTTP).

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus comprising:
a processor configured to process video content from two or more channels; and
a video content storage module comprising at least two buffers, each of the at least two buffers defining a memory portion configured to retain the video content of a selected channel.

2. The apparatus of claim 1, the video content storage module further comprising a digital video recorder (DVR) segment, the DVR segment including a number of DVR recordings of previously stored video content from the two or more channels.

3. The apparatus of claim 1 further comprising:
a content input to receive the video content from the two or more channels; and
a content output to provide the retained video content from at least one of the plurality of buffers to a display device.

4. A method comprising:
receiving video content for at least two channels;
retaining a first channel video content associated with the video content within a first channel buffer of a video content storage module to enable trick play of the first channel video content; and
retaining a second channel video content associated with the video content within a second channel buffer of the video content storage module to enable trick play of the second channel video content.

5. The method of claim 4, further comprising:
retaining video content of at least one additional channel associated with the video content within at least one additional channel buffer of the video content storage module.

6. The method of claim 4, further comprising receiving a first channel selection and second channel section for the video content.

7. The method of claim 6, further comprising:
defining a first portion of the video content storage module as a digital video recorder (DVR) buffer segment; and
defining a second portion of the video content storage module as a DVR recording segment to store one or more DVR recordings of the video content within the DVR recording segment.

8. The method of claim 7, further comprising:
allocating a first channel buffer within the DVR buffer segment for the first channel selection; and
allocating a second channel buffer within the DVR buffer segment for the second channel selection.

9. The method of claim 7, further comprising storing the video content retained within at least one selected from a group including the first channel buffer and second channel buffer as a DVR recording within the DVR recording segment.

10. The method of claim 9, further comprising accessing the DVR recording within the DVR recording segment for at least one selected from a group including subsequent viewing, transferring the DVR recording to a portable playback device, and recording the DVR recording to a digital versatile disc (DVD).

11. The method of claim 4 further comprising providing the video content from at least one selected from a group including the first channel buffer and the second channel buffer to a display device for presentation of the video content.

12. The method of claim 4, further comprising deleting oldest portions of the video content within at least one selected from a group including the first channel buffer and the second channel buffer when no space remains in a corresponding buffer.

13. The method of claim 4, further comprising selecting the video content of at least one selected from a group including the first channel buffer and the second channel buffer for trick play during receipt of the video content.

14. The method of claim 4, further comprising defining a buffer size associated with both the first channel buffer and the second channel buffer.

15. The method of claim 14, further comprising dynamically altering the buffer size of the first channel buffer and the second channel buffer.

16. The method of claim 4, further comprising creating a new channel buffer by reducing buffer allocation of space for the first channel buffer and the second channel buffer by a pro-rata portion and allocating a freed portion of the space to the new channel buffer.

17. The method of claim 4, further comprising selecting at least one selected from a group including fast forwarding the video content, rewinding the video content, recording the video content, repeating the video content, and pausing the video content as trick play.

18. A method comprising:
receiving and retaining video content from a plurality of channels of an Internet Protocol Television (IPTV) within a plurality of buffers of a video content storage module;
receiving a channel change selection for a new IPTV channel;
reallocating a selected buffer from among the plurality of buffers; and
associating the selected buffer with the new IPTV channel.

19. The method of claim 18 further comprising receiving and retaining the video content for the new IPTV channel in the selected buffer.

20. The method of claim 19 further comprising selecting a particular buffer from the plurality of buffers for reallocation and association with the new IPTV channel.

21. The method of claim 20, further comprising selecting at least one selected from a group including at least one of an older buffer and a user designated buffer as the particular buffer.

22. A machine-readable medium comprising instructions, which when executed by a machine, cause the machine to:
receive video content for at least two channels;
retain a first channel video content for the video content within a first channel buffer of a video content storage module; and
retain a second channel video content for the video content within a second channel buffer of the video content storage module.

23. The machine-readable medium of claim 22 further comprising instructions to:
define a first portion of the video content storage module as a digital video recorder (DVR) buffer segment; and
define a second portion of the video content storage module as a DVR recording segment to store one or more DVR recordings of the video content within the DVR recording segment.

24. The machine-readable medium of claim 23 further comprising instructions to:
allocate a first channel buffer within the DVR buffer segment for the first channel selection; and
allocate a second channel buffer within the DVR buffer segment for the second channel selection.

25. The machine-readable medium of claim 23 further comprising instructions to:
provide the video content from at least one selected from a group including the first channel buffer and the second channel buffer to a display device for presentation of the video content.
